(19) United States
(12) Patent Application Publication
(10) Pub. No.: US 2017/0021948 A1
(43) Pub. Date: Jan. 26, 2017

(54) SPACE VEHICLE

(71) Applicant: Israel Aerospace Industries Ltd., LOD (IL)

(72) Inventor: Nissim Yehezkel, Nes Ziona (IL)

(21) Appl. No.: 15/107,063

(22) PCT Filed: Dec. 22, 2014
(86) PCT No.: PCT/IL2014/051119

§ 371 Date: Jun. 21, 2016

(30) Foreign Application Priority Data
Dec. 26, 2013 (IL) 230180

(51) Int. Cl. B64G 1/44; B64G 1/10; B64G 1/22

(52) U.S. Cl. CPC B64G 1/44; B64G 1/222; B64G 1/10

(57) ABSTRACT

Space vehicles are provided, each including a body and a solar panel array system. The body has a longitudinal axis and a plurality of body portions. Adjacent body portions are hinged to one another about a respective body hinge axis to enable the body portions to be selectively pivoted about the respective body hinge axes with respect to one another from an undeployed configuration to a deployed configuration. In the undeployed configuration the body has a first length dimension along a reference axis, and in the deployed configuration the body has a second length dimension along the reference axis. The second length dimension is greater than first length dimension. The solar panel system includes at least two panel sets. Each panel set has at least one solar panel, each panel set being movably mounted to one of the body portions and being selectively deployable from a stowed configuration to an extended configuration. In the stowed configuration the at least one panel of each respective panel set is in circumferentially overlapping relationship with an outside of the body, and in the extended configuration, the panels are projecting away from the respective the body portion. Methods for deploying a space vehicle are also provided.

### TECHNOLOGICAL FIELD

The presently disclosed subject matter relates to space vehicles in general and more specifically with space vehicles that are deployable from a compact configuration.

### PRIOR ART

References considered to be relevant as background to the presently disclosed subject matter are listed below:
Garada SAR Formation Flying Requirements, Space System Baseline and Spacecraft Structural Design (Steven R Tsitas and George Constantinos,

Acknowledgement of the above reference herein is not to be inferred as meaning that this is in any way relevant to the patentability of the presently disclosed subject matter.

### BACKGROUND

Space vehicles have been in use for many years for a variety of uses. For example, Tsitas et al (“Garada SAR Formation Flying Requirements, Space System Baseline and Spacecraft Structural Design”) discloses a mission baseline of the Australian Garada SAR Formation Flying mission, which is designed for operational soil moisture mapping of the Murray Darling Basin from space. An L-Band Synthetic Aperture Radar is disclosed with an antenna size of 15.5 m by 3.9 m, packaged into a spacecraft bus design with a single fold in two symmetrical spacecraft halves.

### GENERAL DESCRIPTION

According to an aspect of the presently disclosed subject matter there is provided a space vehicle comprising a body and a solar panel array system, wherein:
said body comprises a longitudinal axis and a plurality of body portions, adjacent said body portions being serially hinged to one another about a respective body hinge axis to enable said body portions to be selectively pivoted about the respective body hinge axes with respect to one another from an undeployed configuration wherein the body has a first length dimension along a reference axis, to a deployed configuration wherein the body has a second length dimension along the reference axis, wherein said second length dimension is greater than said first length dimension; and
said solar panel system comprises at least two panel sets, each said panel set comprising at least one solar panel, each said panel set being movably mounted to one of said body portions and being selectively deployable from a stowed configuration to an extended configuration, wherein in said stowed configuration the at least one panel of each respective said panel set is in circumferentially overlapping relationship with an outside of said body, and wherein in said extended configuration, said panels are projecting away from the respective said body portion.

According to this aspect of the presently disclosed subject matter there is also provided a space vehicle comprising a body and a solar panel array system, wherein:
said body comprises a longitudinal axis and a plurality of body portions, said body portions being hinged to one another about a respective body hinge axis to enable said body portions to be selectively pivoted about the respective body hinge axes with respect to one another from an undeployed configuration wherein the body has a first length dimension along a reference axis, to a deployed configuration wherein the body has a second length dimension along the reference axis, wherein said second length dimension is greater than said first length dimension; and
said solar panel system comprises at least two panel sets, each said panel set comprising at least one solar panel, each said panel set being movably mounted to one of said body portions and being selectively deployable from a stowed configuration to an extended configuration, wherein in said stowed configuration the at least one panel of each respective said panel set is in circumferentially overlapping relationship with an outside of said body, and wherein in said extended configuration, said panels are projecting away from the respective said body portion.

According to this aspect of the presently disclosed subject matter there is also provided a space vehicle comprising a body and a solar panel array system, wherein:
said body comprises a longitudinal axis and a plurality of body portions, adjacent said body portions being hinged to one another about a respective body hinge axis to enable said body portions to be selectively pivoted about the respective body hinge axes with respect to one another from an undeployed configuration wherein the body has a first length dimension along a reference axis, to a deployed configuration wherein the body has a second length dimension along the reference axis, wherein said second length dimension is greater than said first length dimension; and
said solar panel system comprises at least two panel sets, each said panel set comprising at least one solar panel, each said panel set being movably mounted to one of said body portions and being selectively deployable from a stowed configuration to an extended configuration, wherein in said stowed configuration the at least one panel of each respective said panel set is in circumferentially overlapping relationship with an outside of said body, and wherein in said extended configuration, said panels are projecting away from the respective said body portion.

For example, said reference axis is parallel to the longitudinal axis; alternatively, for example, said reference axis is orthogonal to the longitudinal axis.

For example, said body comprises two said body portions.

Additionally or alternatively, for example, said body hinge axis is at a non-zero angle to said longitudinal axis.

Additionally or alternatively, for example, said body hinge axis is orthogonal to said longitudinal axis; alternatively, for example, said body hinge axis is parallel to said longitudinal axis.

Additionally or alternatively, for example, said body comprises two said body portions and wherein each said body portion comprises a reference face, wherein in said undeployed configuration said reference faces are facing one another, and wherein in said deployed configuration said reference faces are facing a same direction. For example, in said deployed configuration, said reference faces are coplanar. Additionally or alternatively, for example, said reference faces each having a face length dimension along said longitudinal axis, and wherein said reference faces are generally contiguous along said longitudinal axis. Additionally or alternatively, for example, in said deployed configuration said face length dimensions together are equivalent to said second length dimension along the longitudinal axis, and wherein in said undeployed configuration each said face length dimension is equivalent to said first length dimension. Additionally or alternatively, for example, said reference faces each define a SAR array. For example said SAR array comprises a plurality of radiating tiles. For example each said radiating tile comprises a plurality of RF down-conversion units, a plurality of digital beamforming units and a plurality of Gigabits X-links.

Additionally or alternatively, for example, each said body portion has a prismatic form, and said outside comprises a plurality of facets corresponding to a portion of said prismatic form. For example, each said body portion having three said facets. For example, each said body portion comprising a quadrilateral cross-section, wherein three sides of said quadrilateral correspond to said three said facets.

Additionally or alternatively, for example, each said panel set is movably mounted to the same said body portions.

Additionally or alternatively, for example, said body comprises two said body portions and each said panel set is movably mounted to a different one of said two body portions.

Additionally or alternatively, for example, each said panel set comprises a number of said solar panels in adjacent spatial relationship, wherein each adjacent pair of said solar panels is hinged to one another about a respective panel hinge axis.

Additionally or alternatively, for example, each said panel set comprises a number of said solar panels equivalent to the respective number of facets in the respective body portion onto which the respective panel set is mounted.

Additionally or alternatively, for example, in said stowed configuration, each respective said solar panels of each said panel set is in overlapping relationship with a respective said facet of the respective said body portion.

Additionally or alternatively, for example, the space vehicle comprises a suitable drive mechanism for selectively deploying the body portions from the undeployed configuration to the deployed configuration.

Additionally or alternatively, for example, the space vehicle comprises a latch mechanism for selectively locking the body portions together in the deployed configuration.

Additionally or alternatively, for example, the space vehicle comprises a hold and release mechanism (HRM) for selectively holding the body portions together in the undeployed configuration, and for selectively releasing the body portions to allow the body portions to attain the deployed configuration.

Additionally or alternatively, for example, the space vehicle comprises at least one communication antenna. For example, said at least one communication antenna is mounted at a longitudinal end of said body in said deployed configuration. For example, the space vehicle comprises two said communication antennas, and wherein each said communication antenna is mounted at a different longitudinal end of said body in said deployed configuration. For example, said at least one communication antenna is deployable from a retracted position and an extended position.

Additionally or alternatively, for example, the space vehicle has a prelaunch configuration, in which said body portions are in said undeployed configuration and said panel sets are in said stowed configuration.

Additionally or alternatively, for example, the space vehicle has a operational-ready configuration, in which said body portions are in said deployed configuration and said panel sets are in said extended configuration.

For example, the space vehicle is deployable from said prelaunch configuration to said operational-ready configuration by selectively deploying said panel sets from the respective said stowed configuration to the respective extended configuration, and by selectively deploying said body portions from said undeployed configuration to said deployed configuration.

According to this aspect of the presently disclosed subject matter there is also provided a space vehicle comprising a body and a solar panel array system, wherein:
said body comprises a longitudinal axis and two body portions, said two body portions hinged to one another about a first body hinge axis to enable said at least two body portions to be selectively pivoted about the first body hinge axis with respect to one another from an undeployed configuration wherein the body has a first length dimension along the longitudinal axis, to a deployed configuration wherein the body has a second length dimension along the longitudinal axis, wherein said second length dimension is greater than said first length dimension; and
said solar panel system comprises at least two panel sets, each said panel set comprising at least one solar panel, each said panel set being movably mounted to one of said two body portions and being selectively deployable from a stowed configuration to an extended configuration, wherein in said stowed configuration the at least one panel of each respective said panel set are in circumferentially overlapping relationship with an outside of one or more said two body portions, and wherein in said extended configuration, said panels are projecting away from the respective said body portion.

According to this aspect of the presently disclosed subject matter there is also provided a method for deploying a space vehicle, comprising:
providing a space vehicle as defined herein for this aspect of the presently disclosed subject matter;
selectively deploying said panel sets from the respective said stowed configuration to the respective extended configuration;
selectively deploying said body portions from said undeployed configuration to said deployed configuration.

Herein the term “space vehicle” is used synonymously with space craft, space probe, and the like.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 is an isometric view of a first example of a space vehicle according to aspects of the presently disclosed subject matter, in which the body is in the undeployed configuration and the panel sets are in the stowed configuration.

FIG. 2 is an isometric view of the body of example of FIG. 1 in the undeployed configuration.

FIG. 3 is an isometric view of the example of FIG. 1, in which the body is in the deployed configuration and the panel sets are in the extended configuration; FIG. 3(a) is an isometric view of radiating tile of the example of FIG. 3.

FIG. 4(a) is a top perspective view of a body panel of the example of FIG. 2; FIG. 4(b) is a cross sectional view of a body panel of the example of FIG. 2; FIG. 4(c) is a bottom perspective view of a body panel of the example of FIG. 2.

FIG. 5(a) is a front view of the example of FIG. 1; FIG. 5(b) is a front view of the example of FIG. 3.

FIG. 6 is a partial front view of the example of FIG. 3 showing an extended communications antenna; FIG. 6(a) is a partial front view of an alternative variation of the example of FIG. 6.

FIG. 7 is an isometric view of the example of FIG. 1 in prelaunch configuration in a payload bay.

FIG. 8 is an isometric view of the example of FIG. 1 in prelaunch configuration free of the payload bay.

FIG. 9 is an isometric view of the example of FIG. 1 with the body in undeployed configuration and the panel sets in extended configuration.

FIG. 10(a) is a top view of the example of FIG. 1 with the body in deployed configuration and the panel sets in extended configuration; FIG. 10(a) is a bottom view of the example of FIG. 10(a); FIG. 10(c) is an isometric view of the example of FIG. 10(a).

FIG. 11(a) is a front view of an alternative variation of the example of FIG. 1, in which the body is in undeployed configuration and the panel sets are in stowed configuration; FIG. 11(b) is an isometric view of the example of FIG. 11(a) in which the body is in deployed configuration and the panel sets are in extended configuration; FIG. 11(c) is a front view of an alternative variation of the example of FIG. 11(a), in which the body is in undeployed configuration and the panel sets are in stowed configuration.

FIG. 12(a) is a front view of another alternative variation of the example of FIG. 1, in which the body is in undeployed configuration and the panel sets are in stowed configuration; FIG. 12(b) is an isometric view of the example of FIG. 12(a) in which the body is in deployed configuration and the panel sets are in extended configuration.

FIG. 13(a) is a front view of another alternative variation of the example of FIG. 1, in which the body is in undeployed configuration and the panel sets are in stowed configuration; FIG. 13(b) is an isometric view of the example of FIG. 13(a) in which the body is in deployed configuration and the panel sets are in extended configuration; FIG. 13(c) is a front view of an alternative variation of the example of FIG. 13(a), in which the body is in undeployed configuration and the panel sets are in stowed configuration.

FIG. 14(a) is a front view of another alternative variation of the example of FIG. 1, in which the body is in undeployed configuration and the panel sets are in stowed configuration; FIG. 14(b) is an isometric view of the example of FIG. 14(a) in which the body is in deployed configuration and the panel sets are in extended configuration.

FIG. 15(a) is a front view of another alternative variation of the example of FIG. 1, in which the body is in undeployed configuration and the panel sets are in stowed configuration; FIG. 15(b) is an isometric view of the example of FIG. 15(a) in which the body is in deployed configuration and the panel sets are in extended configuration.

### DETAILED DESCRIPTION

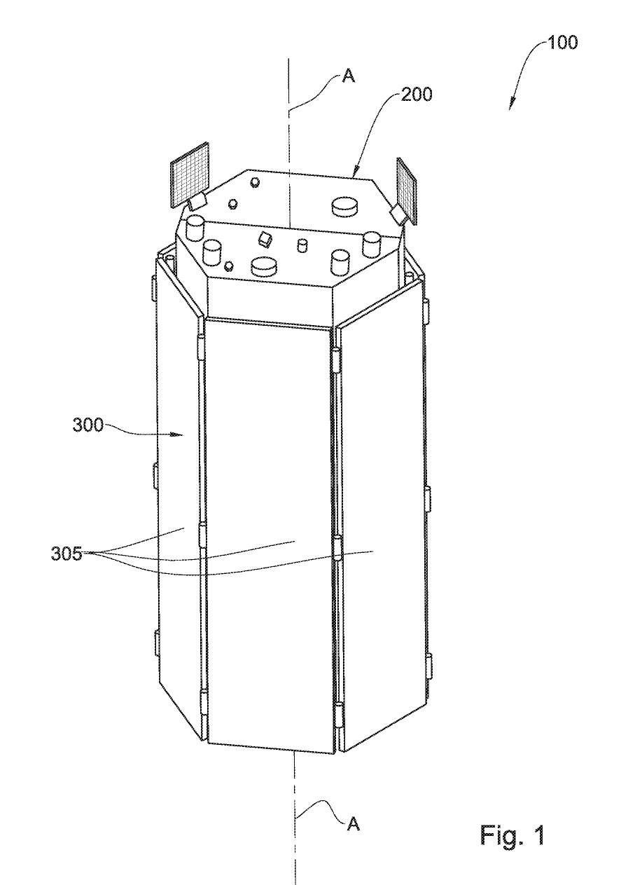

Referring to FIGS. 1, 2 and 3, a space vehicle according to a first example of the presently disclosed subject matter, generally designated 100, comprises a body 200 and a solar panel system 300.

The body 200 has a longitudinal axis A, and comprises two body portions 210, 220, hinged to one another about body hinge axis 250. Thus, a hinge 260 is provided allowing pivoting about body hinge axis 250, and is connected to each respective first longitudinal end 211, 221 of the body portions 210, 220.

In this example, the body 200 is formed primarily of the two body portions 210, 220, which are thus essentially two body halves.

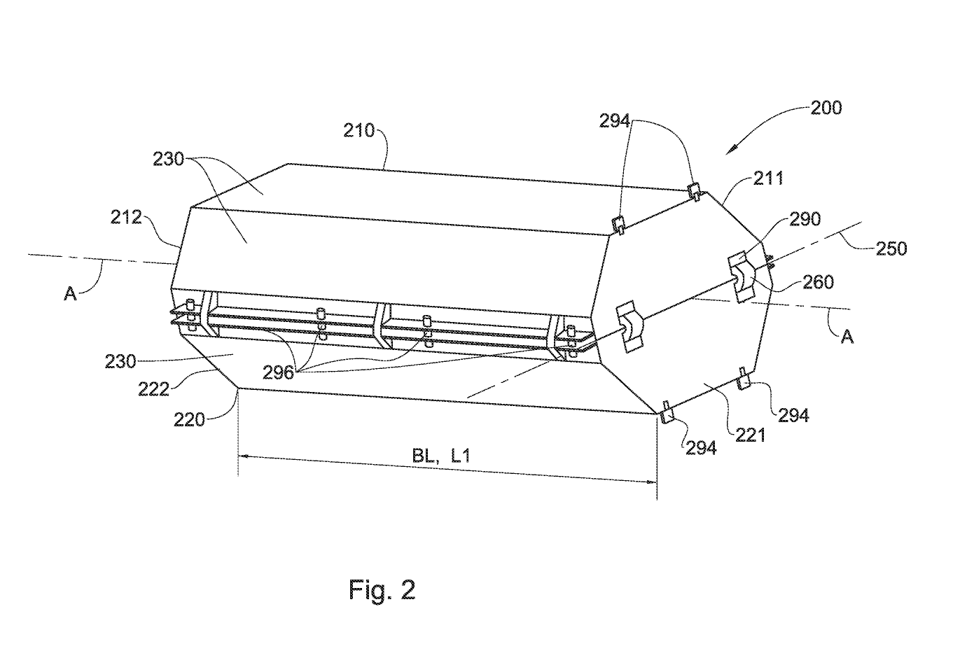

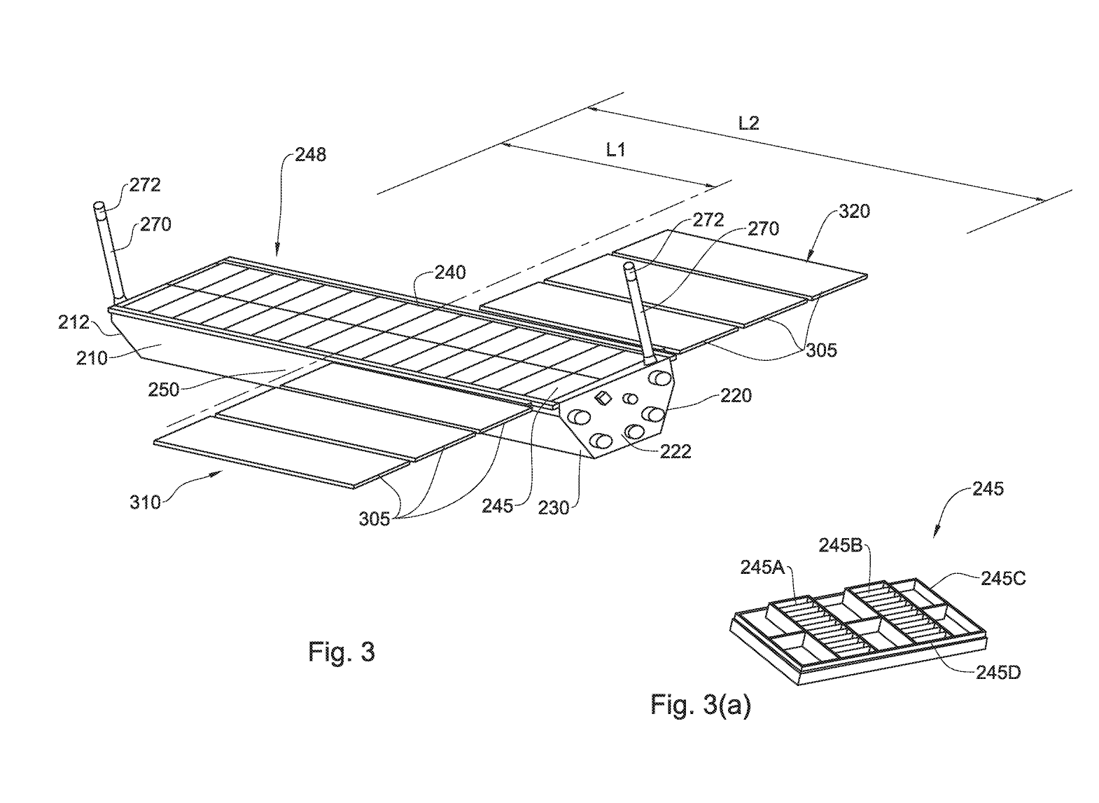

The body portions 210, 220 are pivotable about body hinge axis 250 from an undeployed configuration to a deployed configuration. In the undeployed configuration, illustrated in FIG. 2, the body 200 has a first length dimension L1 along a reference axis parallel to the longitudinal axis A. In the deployed configuration, illustrated in FIG. 3, the body has a second length dimension L2 along a reference axis parallel to the longitudinal axis A. In this example, the two body portions 210, 220 are generally similar in size and shape to one another, though can differ in other details. Thus, each body portion 210, 220 has an axial length BL that is equivalent to the first length dimension L1. It is evident that the second length dimension L2 is greater than the first dimension L1, and in particular that the second length dimension L2 is twice first length dimension L1 for this example.

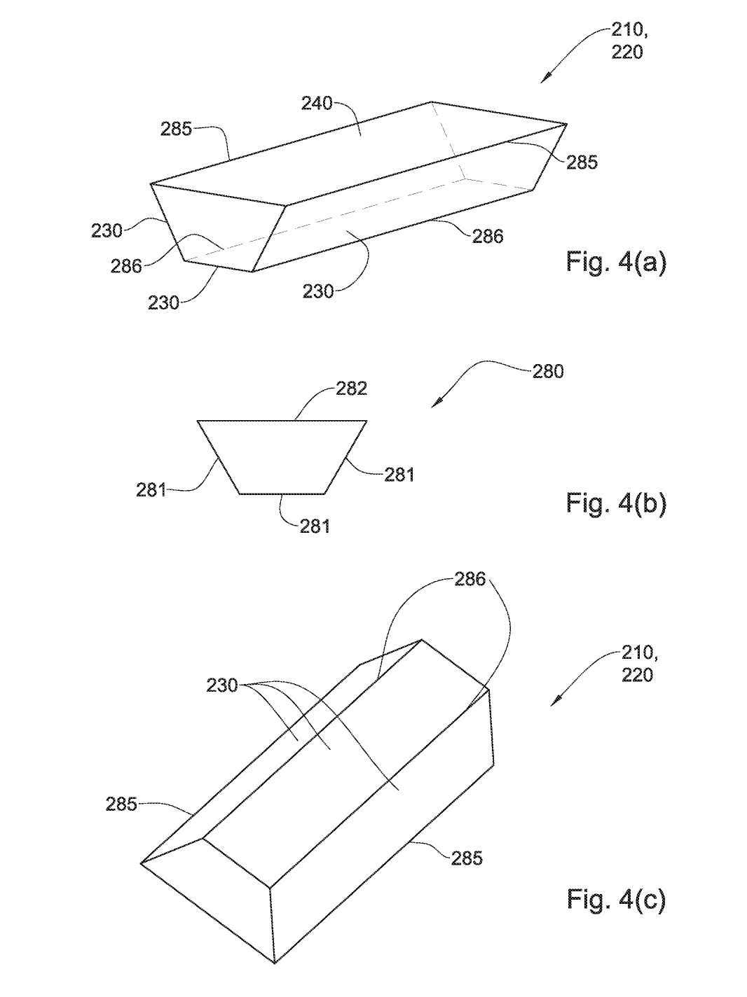

Referring also to FIGS. 4(a), 4(b) and 4(c), each body portion 210, 220 is formed as a prismatic member, having three outer facing facets 230, and a respective reference face 240. Thus, each body portion 210, 220 comprises a general quadrilateral cross section 280 having three sides 281 corresponding to the three facets 230, and a fourth side 282 corresponding to the reference face 240.

In this example, the three facets 230 are similar in size and shape to one another, and each is narrower than respective reference face 240. Thus the three sides 281 are equal in size to one another, and furthermore, the fourth side 282 is parallel to and larger than the central one of the three sides 281. Two longitudinal edges 285 are defined between the respective reference face 240 and a respective one of the two outer facets 230, and two additional longitudinal edges 286 are defined between the respective central facet 230 and each respective two outer facets 230.

Thus, and referring to FIGS. 1 and 2, in the undeployed configuration, the body 100 has a generally hexagonal cross-section, while in the deployed configuration (see FIG. 3), the body has a trapezoidal cross-section corresponding to the quadrilateral; cross section 280.

It is also evident that in the undeployed configuration the reference faces 240 are facing one another, while in the deployed configuration, where the body portions 210, 220 are pivoted by about 180°, the two references faces 240 are facing the same direction.

In this example, and as best seen in FIG. 2, the body hinge axis 250 is orthogonal to, and intersects, the longitudinal axis A.

Referring to FIG. 2, a suitable drive mechanism 290 is provided to selectively deploy the body portions 210, 220 from the undeployed configuration to the deployed configuration. For example, such a drive mechanism 290 can comprise suitable pre-compressed springs, in which the stored potential energy urges the two body portions away from one another to pivot about body hinge axis 250; for example, the springs can be provided at the second longitudinal ends 212, 222 of the body portions 210, 220, or can be integrated in the design of the hinge 260. Alternatively, the drive mechanism 290 can comprise a pyrotechnic piston arrangement or any other suitable arrangement or other drive mechanism coupled to the hinge 260.

Latch mechanism 294 is provided at the first longitudinal ends 211, 221 for selectively locking the two body portions 210, 220 together in the deployed configuration.

Furthermore, hold and release mechanism (HRM) 296 is provided for selectively holding the body portions 210, 220 together in the undeployed configuration, and for selectively releasing the body portions 210, 220 so that they can selectively pivot about body hinge axis 250 to the deployed configuration, driven thereto by the drive mechanism 290. For example, the HRM 296 can comprise a plurality of explosive bolts provided along facing respective longitudinal edges 285 of the body portions 210, 220.

As best seen in FIG. 3, in the deployed configuration, the reference faces 240 are generally coplanar, and are serially disposed and contiguous along the longitudinal axis A.

In this example, the space vehicle 100 is configured as a SAR (synthetic aperture radar) satellite, and the reference faces 240 each comprise a phase array antenna of the SAR, referred to therein as the SAR array 248. For example, the SAR array 248 can be configured to radar mapping the Earth's surface from orbit, and the deployed second length L2 of the body 200, and thus of the SAR array as compared to the undeployed first length L1, provides greater resolution and better images. Referring also to FIG. 3(a), each SAR array 248 comprises a plurality of radiating tiles 245, comprising a plurality of RF down-conversion units 245A, a plurality of digital beamforming units 245B and a plurality of Gigabits X-links, mounted on a mechanical frame 245D. For example, the SAR array 248 can be configured for operating in any suitable band, for example from the X-Band to the L-Band.

In alternative variations of at least this example and in other examples, the space vehicle can be configured for other applications, for example in which it may be advantageous for the space vehicle to have a large dimension along a particular direction (for example along the longitudinal axis A) and/or to provide a large exposed surface area (for example a large flat surface) at the references faces, and wherein it is further advantageous to provide a compact, undeployed configuration for launch. For example, such alternative applications can include providing additional solar cell panels on the reference faces 240, and/or providing imaging cameras at each longitudinal end of the deployed body, the cameras being mounted such that their optical axes are converging, for example for three dimensions imaging.

The body portions 210, 220 each comprise a suitable stiffening structure and regions requiring high mechanical strength (not shown), for example ribs and stiffening members, particular for maintaining planarity of the respective reference face 240 to a predetermined degree, correlated to the proper functioning of the SAR array in this example and/or provide the required antenna planarity. For example, aluminum honeycomb sandwich can be used where stiffness is required, while carbon fiber reinforced plastic (CFRP) can be used where mechanical strength is required. Body portions 210, 220 also comprise a plurality of equipment bays (not shown), for accommodating suitable equipment including for example batteries, computers, attitude control systems, gyroscopes, communication equipment, and so on.

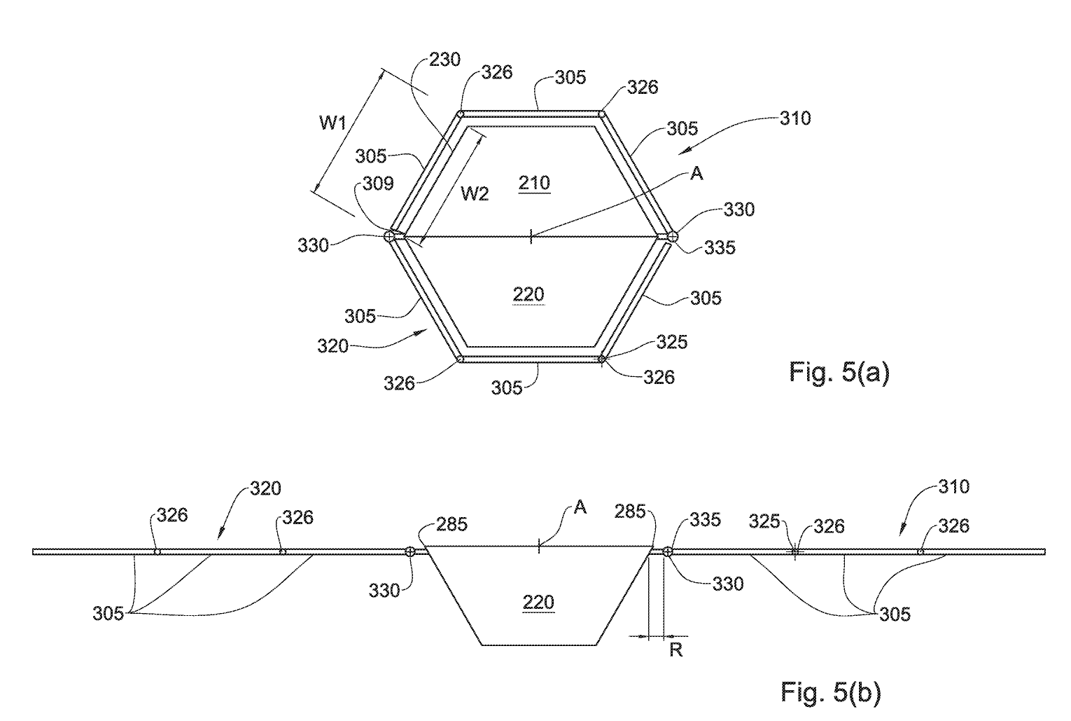

Referring again to FIGS. 1 and 3, the solar panel system 300 comprises, in this example, two panel sets 310, 320. Referring also to FIGS. 5(a) and 5(b), each panel set 310, 320 comprises three solar panels 305, serially hinged to one another by respective panel hinges 326 between each adjacent pair of solar panels 305. Each solar panel 305 comprises a plurality of solar cells, configured for converting solar radiation incident thereon to electrical energy, which can be used for powering the space vehicle 100. In this example, the panel hinges 326 have respective panel hinge axes 325 that are parallel to the longitudinal axis A.

In this example, each panel set 310, 320 are pivotably mounted to the same body portion 220, although in alternative variations of at least this example and in other examples, each panel set 310, 320 is mounted to a different one of the body portions 210, 220, as will become clearer below.

In this example, the panel sets 310, 320 are pivotably mounted to body portion 220 via body-panel hinges 330 which define respective body-panel hinge axes 335. In this example, the body-panel hinges 330 are provides along the respective edges 285, and configured for spacing the body-panel hinge axes 335 from the respective longitudinal edges 285 by a radial displacement R with respect to the longitudinal axis A. In this example, the body-panel hinge axes 335 are parallel to the edges 286 and also to the longitudinal axis A; however, in other alternative variations of at least this example and in other examples, the body-panel hinge axes 335 can be set at an angle to the longitudinal axis A.

In any case, each panel set 310, 320 is selectively deployable from a stowed configuration to an extended configuration. Referring to FIGS. 1 and 5(a), in the stowed configuration the solar panels 305 of each respective panel set are in circumferentially overlapping relationship with an outside of the body 200, the body 200 being in undeployed configuration. In the extended configuration, and referring to FIGS. 3 and 5(b), the solar panels 305 of each panel set 310, 320 are projecting away from the respective body portion 220.

Each panel set 310, 320 is selectively deployable from the stowed configuration to the extended configuration, by selectively pivoting the panel sets 310, 320 about the respective body-panel hinge axes 335 and by pivoting the respective solar panels 305 about the respective panel hinge axes 325.

In this example, each solar panel 305 has a width dimension W1 slightly greater than a width dimension W2 of the facets 230, such that, coupled to the spacing R, allows each solar panel 305 to overlie a respective facet 230 in the stowed configuration, while concurrently the panel hinge axes 325 each overlie a respective edge 286 of one or another of the body portions 210, 220.

In the stowed configuration, the solar panels 305 of each respective panel set are held in said overlying relationship via a suitable hold and release mechanism (HRM) 309, an a suitable drive mechanism (not shown). For example, the HRM 309 can comprise explosive bolts that directly secure the respective panel set 310, 320 to the body 100, or for example a belt (not shown) that circumscribes the outside of all the solar panels 305, the belt being selectively releasable to allow the solar panels to deploy. The drive mechanism for the panel sets can comprise any suitable driver, for example pre-compressed springs coupled to the panel hinges 326 and the body-panel hinges 330.

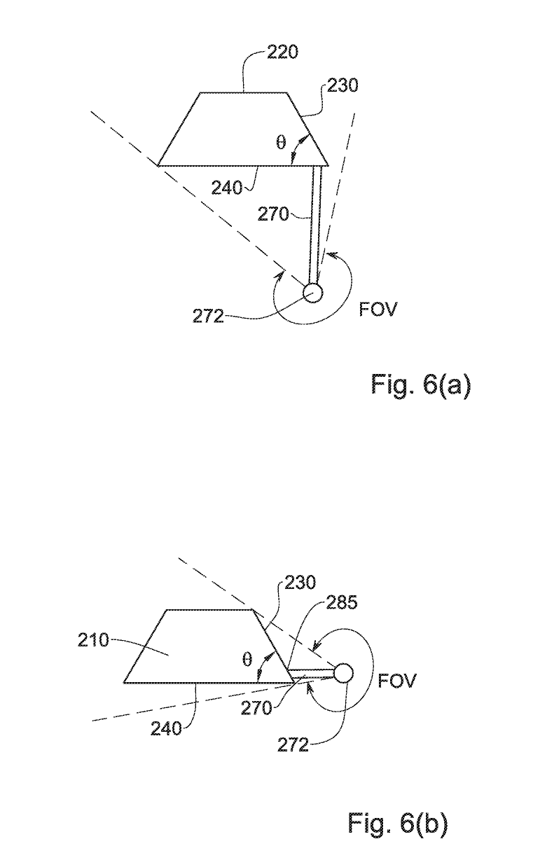

Referring to FIG. 3, the space vehicle 100 further comprises a communications antenna 270 at each one of the second longitudinal ends 212, 222. Each antenna 270 is deployable from a retracted position, in which the antenna is retracted into or in abutment with an outside of the respective body portion 210, 220, and an extended position. In the extended position, the transmitting end 272 of the antenna is projecting from the respective body portion 210, 220, in particular from the reference face 240, close to the longitudinal edges 285 of the respective body portion 210, 220. As best seen in FIG. 6, the trapezoidal cross-section provides an acute angle θ between the respective reference face 240 and the respective outer facets 230, and thus provides each transmitting end 272 with a very wide field of view FOV, only a small part of which is obscured by the space vehicle 100. FIG. 6(a) shows a different configuration for the antenna 270, which projects from the edge 285. Together, the two transmitting end 272 provide a composite FOV that is fully or close to 360° in azimuth and that is fully or close to 360° in elevation. For example, angle θ can be between 10° and 80°, for example between 20° and 70°, for example between 30° and 60°, for example between 40° and 50°.

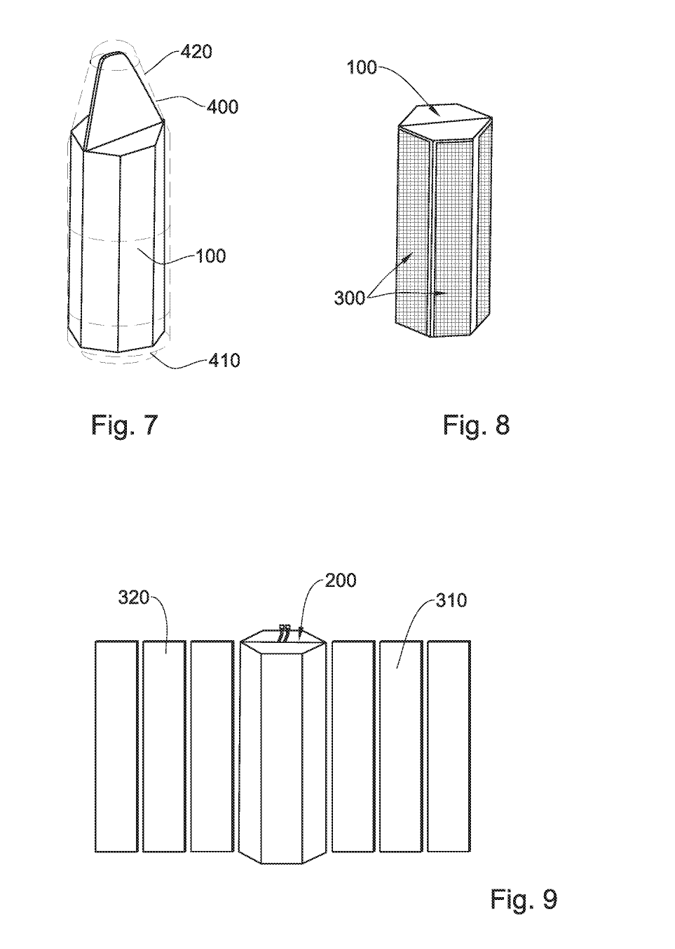

Referring to FIG. 7, in the prelaunch configuration, the space vehicle 100 has the body 200 in the undeployed configuration, and the panel sets 310, 320 are in the stowed configuration. In the prelaunch configuration, the space vehicle 100 fits into a geometrical envelope that fits with the payload bay 400 of a desired launch vehicle, for example an Ariane launch vehicle, and the space vehicle 100 is secured to a mounting station 410, in a manner known per se in the art. The payload bay is typically defined by a payload bay fairing 420 that sits atop the final stage (not shown) of the launch vehicle, for classes of launch vehicles that are launched vertically to earth orbit.

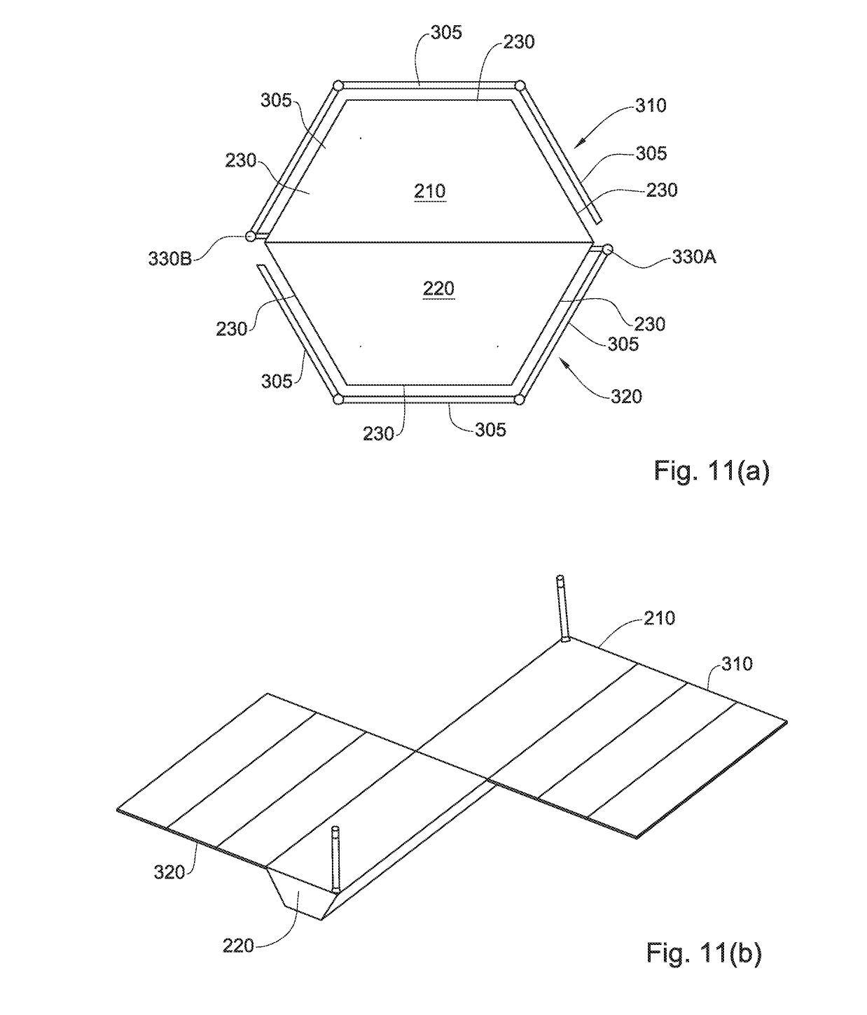

Referring to FIGS. 3, 10(a), 10(b) and 10(c), in the operational-ready configuration, the body 200 is in the deployed configuration, and the panel sets 310, 320 are in the extended configuration. In the operational-ready configuration, the space vehicle 100 can be maneuvered to adopt the desired spatial orientation with respect to the Earth, for example with the SAR array 248 facing the Earth, and/or with the solar panels 305 facing the sun, and the space vehicle 100 is then ready to operate, for example by radar mapping the Earth while orbiting.

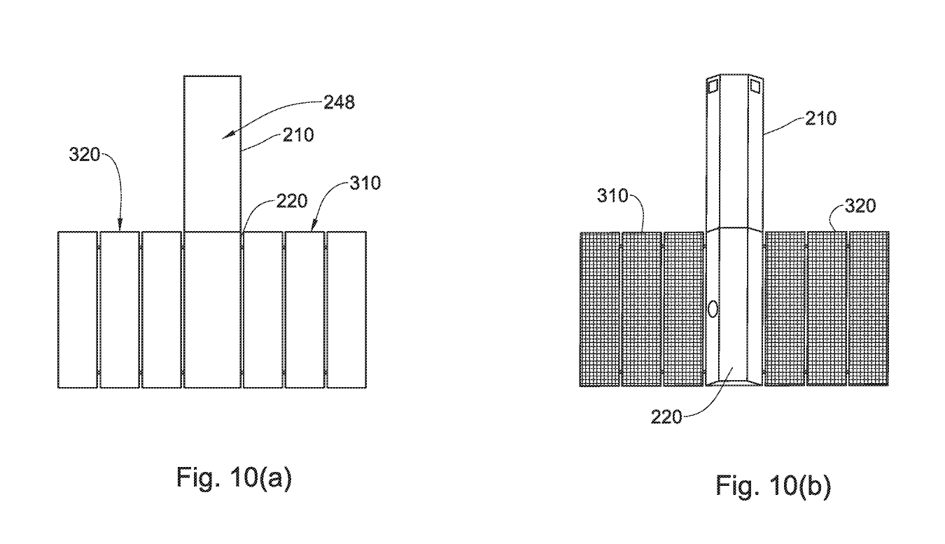

In deployment operation of the space vehicle 100, the space vehicle 100 can be deployed from the prelaunch configuration to the operational-ready configuration as follows. Referring to FIG. 7, the space vehicle 100 remains in the prelaunch configuration while secured in the payload bay 400, and at least until the payload fairing 420 is jettisoned or otherwise removed, and typically also until the space vehicle 100 sheds the final stage as, illustrated in FIGS. 1 and 8. In at least some applications, the space vehicle 100 remains in the prelaunch configuration after this, and until it is desired to begin operations thereof or until it is desired to power the space vehicle 100 via the solar panels thereof.

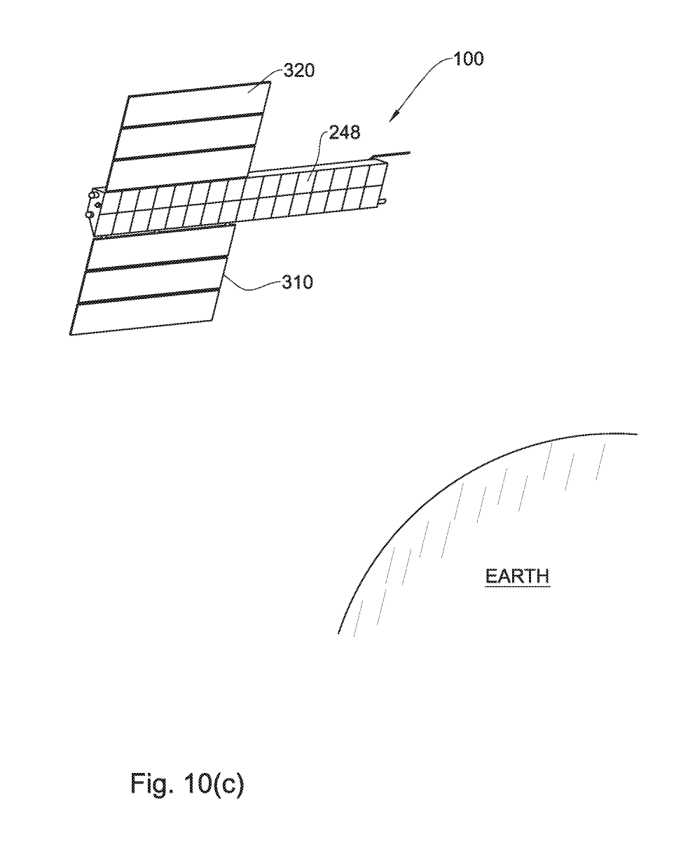

In the first deployment stage of the deployment operation, and referring to FIG. 9, the panel sets 310, 320 are deployed to the extended configuration by releasing the HRM 309 and allowing the drive mechanism for the panel sets 310, 320 to allow the solar panels 305 to deploy. In the extended configuration, the solar panels 305 in each panel set 310, 320 are generally coplanar (see for example FIG. 5(b)) to maximize the efficiency thereof.

In the second deployment stage of the deployment operation, and referring to FIGS. 10(a) to 10(c) and FIG. 2, the body portions 210, 220 are deployed to the deployed configuration, by first releasing the HRM 296, activating the drive mechanism 290 to pivot the body portions 210, 220 about hinge axis 250, and locking the body portions 210, 220 in the deployed configuration via the latch mechanism 294.

Referring also to FIG. 3, in the operational-ready configuration the antennas 270 can be deployed to the extended position, enabling uplink of command signals, and downlink of SAR data.

In alternative variations of the example of FIGS. 1 to 10(c) and in other examples, the outside of the body 200 is not faceted, and can instead comprise any other suitable shape. For example, the outside of body 200 can be cylindrical.

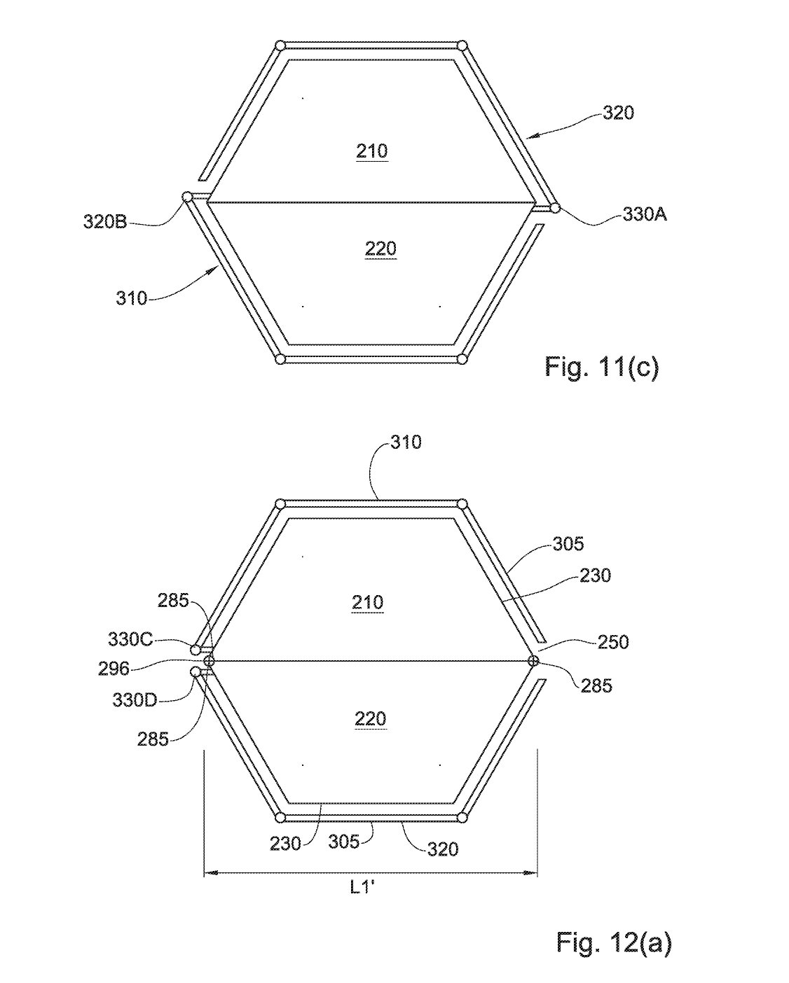

Referring to FIGS. 11(a) and 11(b), and as mentioned above, in an alternative variation of the example of FIGS. 1 to 10(c), each panel set 310, 320 is mounted to a different one of the body portions 210, 220, instead of each panel set 310, 320 being pivotably mounted to the same body portion 210. In the example of FIGS. 11(a) and 11(b), panel set 310 is movably mounted to body portion 210 via respective body-panel hinge 330B, and in the stowed configuration the solar panels 305 of panel set 310 are in overlying relationship with the facts 230 of body portion 210. Similarly, panel set 320 is movably mounted to body portion 220 via respective body-panel hinge 330A, and in the stowed configuration the solar panels 305 of panel set 320 are in overlying relationship with the facts 230 of body portion 220.

Deployment of the example of the space vehicle illustrated in FIGS. 11(a) and 11(b), from the prelaunch configuration to the operational-ready configuration can be as follows (referring also to FIG. 2):
(a) the panel sets 310, 320 are deployed to the extended configuration by releasing the respective HRM 309 and allowing the drive mechanism for the panel sets to allow the solar panels to deploy with respect to each body portion 210, 220;
(b) the body portions 210, 220 are deployed to the deployed configuration, by first releasing the HRM 296, activating the drive mechanism 290 to pivot the body portions 210, 220 about hinge axis 250, and locking the body portions 210, 220 in the deployed configuration via the latch mechanism 294.

It is to be noted that for this example, step (a) can precede or alternatively can follow step (b).

In another alternative variation of the example of FIG. 11(a), and referring to FIG. 11(c), panel set 310 is movably mounted to body portion 210 via respective body-panel hinge 330B, but in the stowed configuration the solar panels 305 of panel set 310 are in overlying relationship with the facts 230 of body portion 220. Similarly, while panel set 320 is movably mounted to body portion 220 via body-panel hinge 330A, in the stowed configuration the solar panels 305 of panel set 320 are in overlying relationship with the facts 230 of body portion 210. In this example, step (a) precedes step (b) when deploying the space vehicle from the prelaunch configuration to the operational-ready configuration.

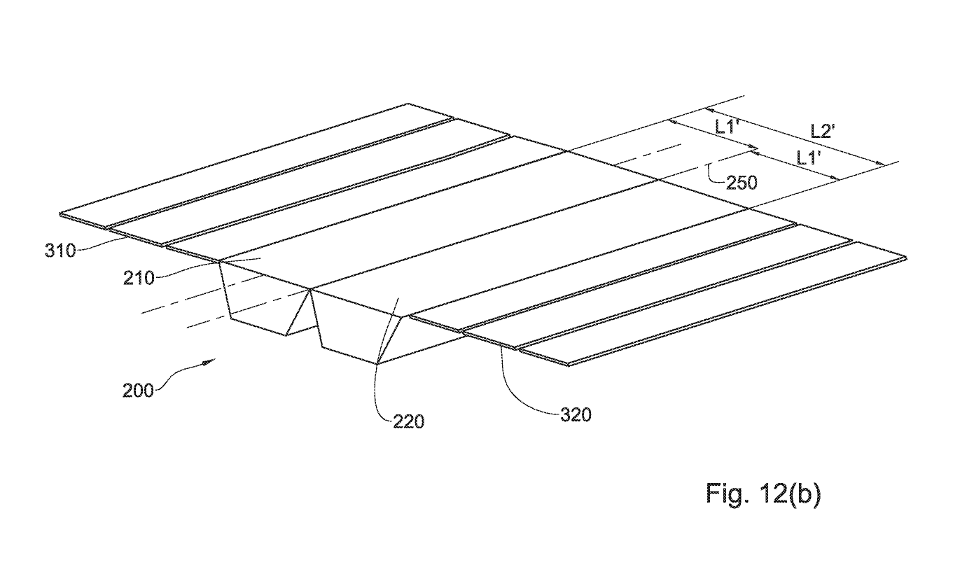

In another alternative variation of the example of FIGS. 1 to 10(c), and referring to FIGS. 12(a) and 12(b), the body hinge axis 250 is parallel to the longitudinal axis A, and is located along or near one edge 285. In this example, panel set 310 is movably mounted to body portion 210 via body-panel hinge 330C, and in the stowed configuration the solar panels 305 of panel set 310 are in overlying relationship with the facts 230 of body portion 210. Similarly, panel set 320 is movably mounted to body portion 220 via body-panel hinge 330D, in the stowed configuration the solar panels 305 of panel set 320 are in overlying relationship with the facts 230 of body portion 220. As may be seen from FIG. 12(a), in the undeployed configuration, the body-panel hinges 330C, 330D are facing one another, and respective HRM 296 are provided along the corresponding facing sides 285.

Deployment of the example of the space vehicle illustrated in FIGS. 12(a) and 12(b), from the prelaunch configuration to the operational-ready configuration can be as follows:
(i) the panel sets 310, 320 are deployed to the extended configuration by releasing the respective HRM (not shown) and allowing the drive mechanism (not shown) for the panel sets to allow the solar panels 305 to deploy with respect to each body portion 210,220;
(ii) the body portions 210, 220 are deployed to the deployed configuration, by first releasing the HRM 296, activating the drive mechanism (not shown) to pivot the body portions 210, 220 about hinge axis 250 (that is parallel to longitudinal axis A), and locking the body portions 210, 220 in the deployed configuration via a suitable latch mechanism (not shown).

It is to be noted that for this example, step (i) can precede or alternatively can follow step (ii).

As is evident from FIGS. 12(a) and 12(b), the body 200 in this example also has a first length dimension L1′ along a reference axis orthogonal to longitudinal axis A in the undeployed configuration, and in the deployed configuration, the body has a second length dimension L2′ along the reference axis orthogonal to longitudinal axis A. It is evident that the second length dimension L2′ is greater than the first dimension L1′, and in particular that the second length dimension L2′ is twice first length dimension L1′ for this example.

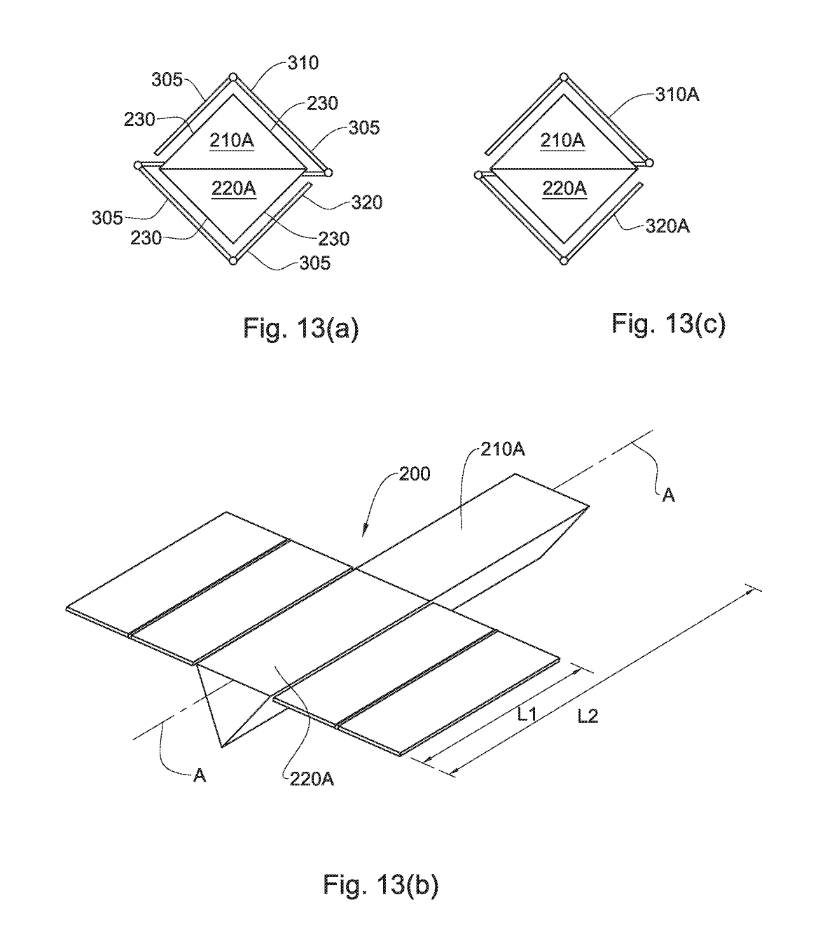

In another alternative variation of the example of FIGS. 1 to 12(b), and referring to FIGS. 13(a) and 13(b), the two body portions, designated 210A, 220A are substantially similar to body portions 210, 220, respectively, as disclosed herein, mutatis mutandis, with the following differences. In the example of FIGS. 13(a) and 13(b), the two body portions 210A, 220A, while similar in shape and size to one another, each have only two facets 230. Thus, the uniform cross-section of each body portion 210A, 220A is triangular, and furthermore, each respective panel set, designated 310A, 320A, comprises two solar panels 305, each in overlying relationship with respect to a facet 230 in the stowed configuration. In the example of FIGS. 13(a) and 13(b), the two panel sets 310A, 320A are movably mounted to the same body portion 220A, and the deployment operation to deploy the respective space vehicle from the prelaunch configuration to the operational-ready configuration is similar to that of the example of FIGS. 1 to 10(c), mutatis mutandis.

Alternatively, and referring to FIG. 13(c), one panel set 310A is mounted to body portion 210A, and in the stowed configuration the solar panels 305 of panel set 310 are in overlying relationship with the facets 230 of body portion 210A (or alternatively with the facets of body portion 220A), while panel set 320A is mounted to body portion 220A, and in the stowed configuration the solar panels 305 of panel set 320A are in overlying relationship with the facts 230 of body portion 220A (or alternatively with the facets of body portion 220A, respectively). In such cases, the deployment operation to deploy the respective space vehicle from the prelaunch configuration to the operational-ready configuration is similar to that of the example of FIGS. 11(a) and 11(b) (or the example of FIG. 11(c), respectively), mutatis mutandis.

As is evident from FIG. 13(b), the body 200A in this example also has a first length dimension L1 along a reference axis parallel to the longitudinal axis A in the undeployed configuration, and in the deployed configuration, the body has a second length dimension L2 along a reference axis parallel to the longitudinal axis A. It is evident that the second length dimension L2 is greater than the first dimension L1, and in particular that the second length dimension L2 is twice first length dimension L1 for this example.

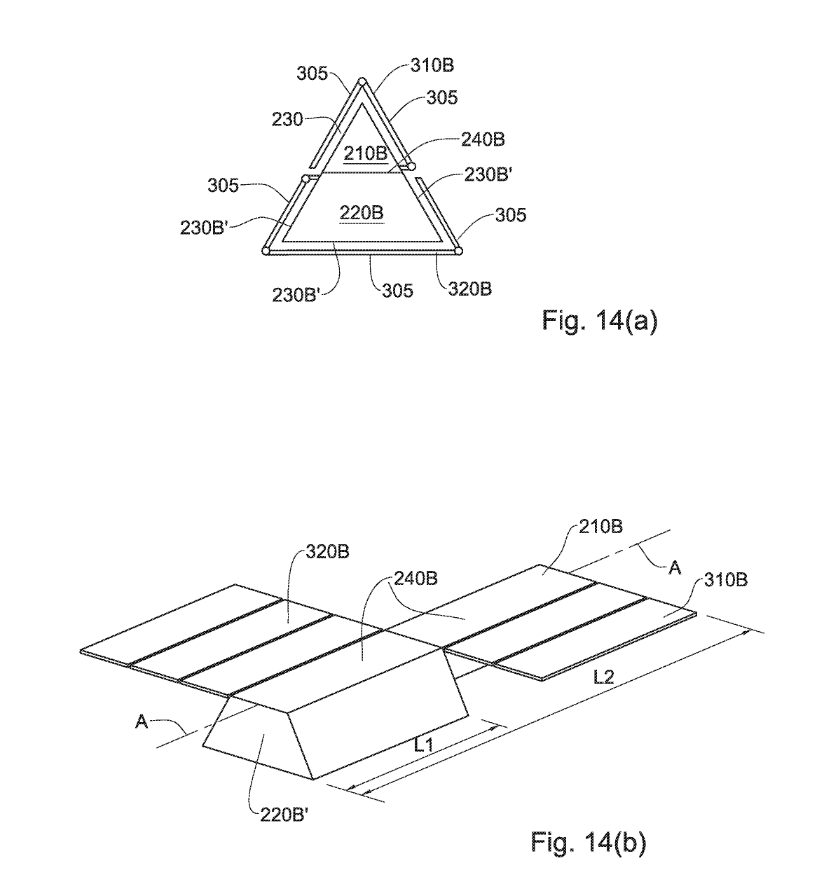

In another alternative variation of the examples of FIGS. 1 to 13(c), and referring to FIGS. 14(a) and 14(b), the two body portions, designated 210B, 220B are substantially similar to body portions 210, 220, respectively, as disclosed herein, mutatis mutandis, with the following differences. In the example of FIGS. 14(a) and 14(b), the two body portions 210B, 220B, are not similar in shape and overall size to one another, though in this example have similar axial length along the longitudinal axis A. While body portion 210B has only two facets, designated 230B, body portion 220B has three facets, designated 230B′; at the same time, the respective reference faces, designated 240B are substantially similar in size and shape. Thus, the uniform cross-section of body portion 210B is triangular, while the uniform cross-section of body portion 220B is trapezoidal. Furthermore, one respective panel set, designated 310B, comprises two solar panels 305, each in overlying relationship with respect to a facet 230B in the stowed configuration, and the panel set 310B is movably mounted to the body portion 210B; the other respective panel set, designated 320B, comprises three solar panels 305, each in overlying relationship with respect to a facet 230B′ in the stowed configuration, and the panel set 320B is movably mounted to the body portion 220B. In the example of FIGS. 14(a and 14(b) the deployment operation to deploy the respective space vehicle from the prelaunch configuration to the operational-ready configuration is similar to that of the example of FIGS. 11(a) and 11(b), mutatis mutandis.

As is evident from FIGS. 14(b), the body 200B in this example also has a first length dimension L1 along a reference axis parallel to the longitudinal axis A in the undeployed configuration, and in the deployed configuration, the body has a second length dimension L2 along the reference axis parallel to the longitudinal axis A. It is evident that the second length dimension L2 is greater than the first dimension L1, and in particular that the second length dimension L2 is twice first length dimension L1 for this example.

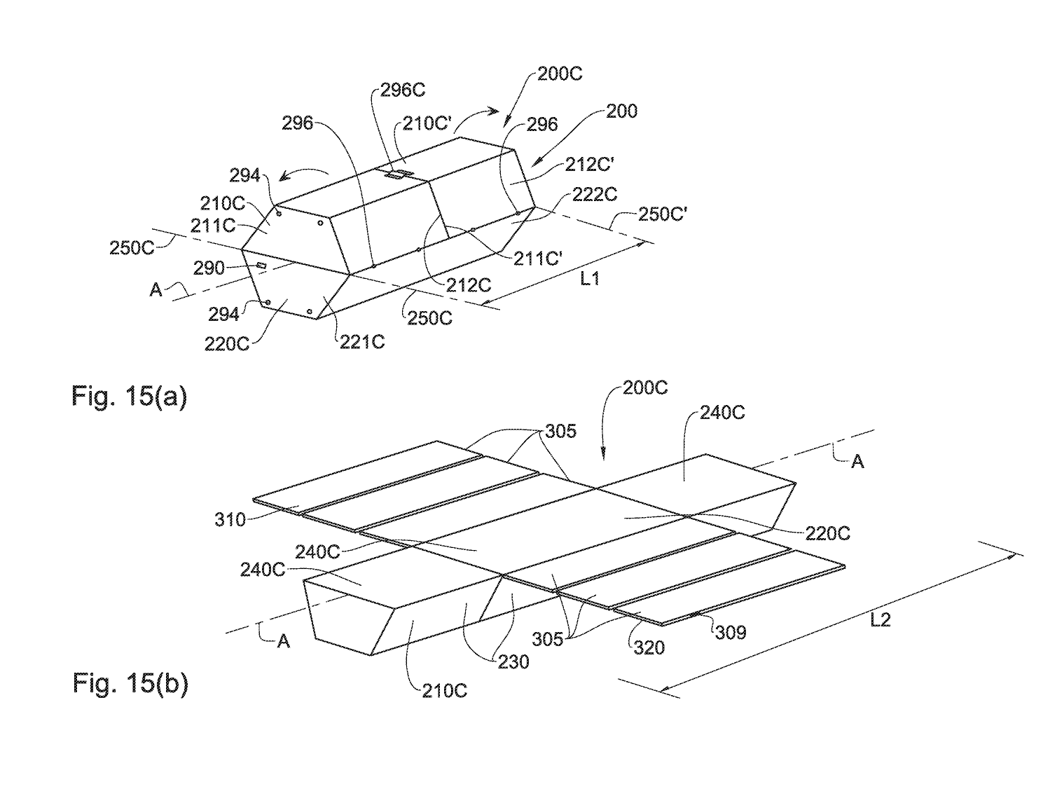

In another alternative variation of the examples of FIGS. 1 to 14(b), and referring to FIGS. 15(a) and 15(b), the body 200 comprises three body portions, designated 210C, 210C′ and 220C. Body portion 220C is substantially similar to body portion 220, as disclosed herein regarding the example of FIGS. 1 to 3, mutatis mutandis, with some differences. The other two portions 210C, 210C′ together are equivalent to body portion 210 as disclosed herein regarding the example of FIGS. 1 to 3, mutatis mutandis. Each of the two portions 210C, 210C′ is pivotably mounted to one or another of respective longitudinal ends 221C, 222C of body portion 220C via respective body hinge axes 250C and 250C′. Thus, in the undeployed configuration, illustrated in FIG. 15(a), the two body portions 210C, 210C′ are in overlying relationship with the body portion 220C, while in the deployed configuration, illustrated in FIG. 15(b), the three body portions 210C, 220C, 20C′ are in serial contiguous relationship, with the reference faces thereof 240C being coplanar.

A suitable hold and release mechanism (HRM) 296 is provided for selectively holding each of the body portions 210C and 210C′ with body portion 220C together in the undeployed configuration, and for selectively releasing the portions 210C and 210C′ with respect to body portion 220C, so that they can selectively pivot about body hinge axes 250C to the deployed configuration, driven thereto by the drive mechanism 290, for example, as disclosed for the example of FIGS. 1 to 10(c), mutatis mutandis. In the deployed configuration, the reference faces 240C of the three body portions 210C, 210C′ and 220C are coplanar, and are serially disposed and contiguous along the longitudinal axis A.

Latch mechanism 294 is provided at first longitudinal ends 211C, 221C of the body portions 210C, 220C for selectively locking the body portions 210C, 220C together in the deployed configuration, and another latch mechanism 294 is provided at second longitudinal ends 212C′, 222C of the body portions 210C′, 220C for selectively locking the body portions 210C′, 220C together in the deployed configuration. An additional suitable hold and release mechanism (HRM) 296C is optionally provided at the second longitudinal end 212C of the body portion 210C and at the first longitudinal end 211C′ of body portion 210C′ for selectively locking the two body portions 210C, 210C′ together in the undeployed configuration, and for selectively releasing the two body portions 210C, 210C′ to allow the body to adopt the deployed configuration.

Each body portion 210C, 210C′ is released, pivoted and locked in place with respect to the body portion 220C in a similar manner to that disclosed for body portion 210 with respect to body portion 220, mutatis mutandis. In this example, the two panel sets 310, 320 each comprises three solar panels 305, and are movably mounted to the body portion 220C. Each of the three solar panels 305 of panel set 320 are in overlying relationship with respect to a facet 230 of body portion 220B in the stowed configuration, while each of the three solar panels 305 of panel set 310 is in overlying relationship with respect to a facet 230 of each one of body portion 210C and 201C′ in the stowed configuration, for example in a similar manner to the example of FIGS. 5(a) and 5(b), mutatis mutandis.

Deployment of the example of the space vehicle illustrated in FIGS. 15(a) and 15(b) from the prelaunch configuration to the operational-ready configuration can be as follows:
(a) the panel sets 310, 320 are deployed to the extended configuration by releasing the respective HRM 309 and allowing the drive mechanism for the panel sets to allow the solar panels to deploy with respect to body portion 220C, i.e., in a similar manner to the example of FIGS. 10(a) to 10(c), mutatis mutandis;
(b) each of the body portions 210C and 210C′, is deployed with respect to body portion 220C to the deployed configuration, in a similar manner to the deployment of body portion 210 with respect to body portion 220, mutatis mutandis. Thus, body portion 210C is deployed with respect to body portion 220C by first releasing the respective HRM 296, activating the respective drive mechanism 290 to pivot the body portions 210C, 220C about the respective hinge axis 250C, and locking the body portions 210C, 220C in the deployed configuration via the respective latch mechanism 294. Similarly, body portion 210C′ is deployed with respect to body portion 220C by first releasing the respective HRM 296, activating the respective drive mechanism 290 to pivot the body portions 210C′, 220C about the respective hinge axis 250C, and locking the body portions 210C, 220C in the deployed configuration via the respective latch mechanism 294.

As is evident from FIG. 15(b), the body 200C in this example also has a first length dimension L1 along a reference axis parallel to the longitudinal axis A in the undeployed configuration, and in the deployed configuration, the body 200C has a second length dimension L2 along the reference axis, parallel to the longitudinal axis A. It is evident that the second length dimension L2 is greater than the first dimension L1, and in particular that the second length dimension L2 is twice first length dimension L1 for this example.

In the method claims that follow, alphanumeric characters and/or Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the spirit of the presently disclosed subject matter.

1-19. (canceled)

20. A space vehicle, comprising:
a body; and
a solar panel array system;
wherein:
said body includes a longitudinal axis and a plurality of body portions, adjacent ones of said plurality of body portions being hinged to one another about a respective body hinge axis to enable said plurality of body portions to be selectively pivoted about the respective body hinge axes with respect to one another from an undeployed configuration wherein the body has a first length dimension along a reference axis, to a deployed configuration wherein the body has a second length dimension along the reference axis, wherein said second length dimension is greater than said first length dimension; and
said solar panel system includes at least two panel sets, each of said at least two panel sets including at least one solar panel, each of said at least two panel sets being movably mounted to one of said plurality of body portions and being selectively deployable from a stowed configuration to an extended configuration, wherein in said stowed configuration the at least one solar panel of each respective one of said at least two panel sets is in circumferentially overlapping relationship with an outside of said body, and wherein in said extended configuration, said solar panels are projecting away from the respective said body portion.

21. The space vehicle according to claim 20, further including at least one of the following features:
wherein said reference axis is substantially parallel to the longitudinal axis;
wherein said reference axis is substantially orthogonal to the longitudinal axis;
wherein said body includes two said body portions;
wherein said body hinge axis is at a non-zero angle to said longitudinal axis; or
wherein said body hinge axis is substantially orthogonal to said longitudinal axis or wherein said body hinge axis is substantially parallel to said longitudinal axis.

22. The space vehicle according to claim 20, wherein said body includes two body portions, and wherein each of said two body portion includes a reference face, wherein in said undeployed configuration said reference faces are facing one another, and wherein in said deployed configuration said reference faces are facing a same direction.

23. The space vehicle according to claim 22, wherein in said deployed configuration, said reference faces are substantially coplanar.

24. The space vehicle according to claim 22, wherein said reference faces each define a synthetic aperture radar (SAR) array.

25. The space vehicle according to claim 24, wherein said SAR array includes a plurality of radiating tiles.

26. The space vehicle according to claim 20, wherein each of said plurality of body portions has a prismatic form, and said outside includes a plurality of facets corresponding to a portion of said prismatic form.

27. The space vehicle according to claim 26, each said plurality of body portions having three said facets.

28. The space vehicle according to claim 20, wherein each of said at least two panel sets is movably mounted to the same one of said plurality of body portions.

29. The space vehicle according to claim 20, wherein said body includes two body portions, and each of said at least two panel sets is movably mounted to a different one of said two body portions.

30. The space vehicle according claim 20, wherein each of said at least two panel sets includes a number of said solar panels in an adjacent spatial relationship, wherein each adjacent pair of said number of solar panels is hinged to one another about a respective panel hinge axis.

31. The space vehicle according to claim 26, wherein each of said at least two panel sets includes a number of said solar panels equivalent to a respective number of facets in the respective body portion onto which the respective panel set is mounted.

32. The space vehicle according to claim 26, wherein in said stowed configuration, each respective one of said solar panels of each of said at least two panel sets is in an overlapping relationship with a respective said facet of the respective said body portion.

33. The space vehicle according to claim 20, further comprising at least one of:
a drive mechanism for selectively deploying the body portions from the undeployed configuration to the deployed configuration;
a latch mechanism for selectively locking the body portions together in the deployed configuration; or
a hold and release mechanism (HRM) for selectively holding the body portions together in the undeployed configuration, and for selectively releasing the body portions to allow the body portions to attain the deployed configuration.

34. The space vehicle according to claim 20, further comprising at least one communication antenna, wherein said at least one communication antenna is mounted at a longitudinal end of said body in said deployed configuration, and wherein said at least one communication antenna is deployable from a retracted position and an extended position.

35. The space vehicle according to claim 20, wherein said space vehicle has a prelaunch configuration, in which said body portions are in said undeployed configuration and said panel sets are in said stowed configuration, and wherein said space vehicle has an operational-ready configuration, in which said body portions are in said deployed configuration and said panel sets are in said extended configuration.

36. The space vehicle according to claim 35, wherein said space vehicle is deployable from said prelaunch configuration to said operational-ready configuration by selectively deploying said at least two panel sets from the respective said stowed configuration to the respective extended configuration, and by selectively deploying said body portions from said undeployed configuration to said deployed configuration.

37. A space vehicle, comprising:
a body; and
a solar panel array system;
wherein:
said body includes a longitudinal axis and two body portions, said two body portions hinged to one another about a first body hinge axis to enable said two body portions to be selectively pivoted about the first body hinge axis with respect to one another from an undeployed configuration wherein the body has a first length dimension along the longitudinal axis, to a deployed configuration wherein the body has a second length dimension along the longitudinal axis, wherein said second length dimension is greater than said first length dimension; and
said solar panel system includes at least two panel sets, each of said at least two panel sets including at least one solar panel, each of said at least two panel sets being movably mounted to one of said two body portions and being selectively deployable from a stowed configuration to an extended configuration, wherein in said stowed configuration the at least one panel of each respective said panel set are in circumferentially overlapping relationship with an outside of one or more said two body portions, and wherein in said extended configuration, said panels are projecting away from the respective said body portion.

38. A method for deploying a space vehicle, comprising:
providing a space vehicle as defined in claim 20;
selectively deploying said at least two panel sets from the respective said stowed configuration to the respective extended configuration; and
selectively deploying said body portions from said undeployed configuration to said deployed configuration.

39. A method for deploying a space vehicle, comprising:
providing a space vehicle as defined in claim 37;
selectively deploying said at least two panel sets from the respective said stowed configuration to the respective extended configuration; and
selectively deploying said body portions from said undeployed configuration to said deployed configuration.
